(19) United States
(12) Patent Application Publication
(10) Pub. No.: US 2008/0314471 A1
(43) Pub. Date: Dec. 25, 2008

(54) Pipe Fitting

(76) Inventor: Graeme Bulmer, Tyne & Wear (GB)

Correspondence Address: MORGAN LEWIS & BOCKIUS LLP, 1111 PENNSYLVANIA AVENUE NW, WASHINGTON, DC, 20004, US

(21) Appl. No.: 11/886,218

(22) PCT Filed: Feb. 28, 2006
(86) PCT No.: PCT/GB2006/000723

§ 371 Date: Aug. 27, 2008

(30) Foreign Application Priority Data
Mar. 14, 2005 (GB) 0505207.1

(51) Int. Cl. F16L 11/00

(52) U.S. Cl. 138/127; 138/137; 138/130; 138/135; 428/36.91

(57) ABSTRACT

A multi-layer flexible pipe and method for making the same is disclosed. The multi-layer flexible pipe includes a barrier layer of polyamide-12 (PA-12) material.

The present invention relates to a multi-layer flexible pipe of the type for conveying oil or gas or other such fluid. In particular, but not exclusively, the present invention provides such a flexible pipe and a method for manufacturing such a flexible pipe which has a desirable chemical and temperature resistance and which has a desirable flexibility.

There are different types of submarine pipes. These are pipes which may be sunk under great depths of sea and which can be used to convey bore fluids such as crude oil or gas or some other such fluid from a collection point to a delivery point. It will be understood that such pipes are also applicable to overland and shallow water applications. It is well known that in the art these types of pipes are divided into two broad classes, namely rigid pipes and flexible pipes. The former are normally made of steel and may sometimes be coated in concrete. They are capable of being laid in very deep water. Flexible pipes are normally made up of a number of layers of composites and reinforcing materials such as steel braids. Since the walls of such flexible pipes are made up of a number of interacting layers those walls tend to be thick.

In such a typical and well known “flexible pipe” fluid to be conveyed flows down a central bore which is formed by a core layer which is often referred to as a carcass. An inner surface of this core layer determines the bore whilst an outer surface must be made impervious to penetration by the fluid flowing in the bore. A bore-fluid retaining layer is thus formed at the outer surface of the carcass. This forms a barrier layer which helps prevent oil or gas escaping from the central bore. The layer also prevents ingress of fluid which may otherwise contaminate the bore-fluid. It is known that a polyamide can be used for this barrier layer, particularly a polyamide-11 is often used. Other layers are formed outwardly in the multi-layer flexible pipe. For example a set of layers of reinforcement wires and an external protection sheath.

One problem associated with flexible pipes of this type is that they are required to flex. This permits the pipe to be laid using a rolling process and also permits the pipe to flex under conditions on site without failure. A particular problem posed by this is that the materials forming each of the layers in such a flexible pipe must be selected so as to produce a desired level of flexibility and also longevity. Flexible pipes also need a temperature and pressure resistance so that they can perform for periods of time over twenty years and in some instances over twenty five years.

Also the pipes must have a high chemical resistance so that they can continue to function at a rate of chemical degration which does not compromise physical performance unduly. Also, operation within predetermined thresholds must be maintained. For example, for known pipes the chemical property that is Corrected Inherent Viscosity shall always be higher than 1.0 dl/g and preferably higher than 1.2 dl/g.

Achieving a pipe and a method of producing such a pipe is a complex and costly process.

Standard polyamide (PA)-12 is a well known material for extrusion of small, thin walled pipes with respect to processability. melt viscosity and melt stiffness. Here, by thin walled, is meant of the order of 1 mm thick layers in a small diameter pipe of perhaps 1 cm diameter. However, at processing temperatures of 210-250° C. the melt stiffness of standard PA-12 for extrusion applications having greater thicknesses of PA-12 layer and thus for use with larger diameter pipes is not high enough to reach constant pipe geometries. This would impair the functionality of flexible pipes using standard PA-12 as a barrier layer as the overlying layers of wound steel require consistent geometries. It is generally known, for example, to make a barrier layer having a thickness of 5+mm and preferably having a thickness in the range of 6-12 mm. In order to achieve good processing conditions, and consistent geometries, for large diameter pipe the extrusion temperature would have to be reduced. However, doing this would result in high residual stresses in the pipe. These residual stresses would also impair the functionality of a flexible pipe using standard PA-12 as a barrier, by increasing the materials notch sensitivity and degrading its fatigue performance. It should be emphasized that for these reasons a PA-12 material has not been used for large diameter pressure retaining tubes, for example the fluid barriers in flexible pipe, as it has been felt that it is unlikely such grades would fulfil the ISO 13628-2:2000 and API 17J qualification requirements.

It is an aim of the present invention to at least partly mitigate the above-mentioned problems.

It is an aim of embodiments of the present invention to provide a flexible pipe having an extended lifetime for a given cumulative temperature and chemical exposure, compared to known flexible pipes using known polyamide barrier layers.

It is an aim of embodiments of the present invention to provide a flexible pipe which ages at a slower rate, for a given cumulative temperature and chemical exposure, compared to known flexible pipes using known polyamide barrier layers.

It is an aim of embodiments of the present invention to provide a flexible pipe providing similar lifetimes to known flexible pipes, but at greater cumulative temperature and chemical exposure.

It is an aim of embodiments of the present invention to provide a flexible pipe having a barrier layer manufactured from a material which provides better mechanical properties than barrier layers formed by previously used materials at a given corrected inherent viscosity.

It is an aim of embodiments of the present invention to provide a flexible pipe having a barrier layer in which the aging acceptance limit can be reduced compared to previously used materials.

It is an aim of embodiments of the present invention to provide a method for producing such a flexible pipe.

In accordance with the first aspect of the present invention there is provided a multi-layer flexible pipe for conveying a target fluid, comprising:

at least one barrier layer of polyamide-12 (PA-12), for providing internal fluid integrity.

In accordance with a second aspect of the present invention there is provided a method for providing a multi-layer flexible pipe for conveying a target fluid comprising the steps of:

providing at least one barrier polymer layer of polyamide-12 (PA-12) for providing internal fluid integrity.

Embodiments of the present invention provide a multi-layer flexible pipe which includes, as a barrier layer, or as part of a fluid barrier layer, a polymer layer having a chemical decay (hydrolysis) resistance which is sufficient to ensure a Corrected Inherent Viscosity of greater than known acceptance limits of 1.0 dl/g, so that the polymer layer always satisfies desired fracture toughness and ductility even at its end of life. This ensures that the flexible pipe will be flexible enough to be located at a desired location and to perform adequately at that location for twenty or more years, for a given cumulative temperature and chemical exposure.

Embodiments of the present invention provide a multi-layer flexible pipe which includes, as a barrier layer, or as part of a fluid barrier layer, a polyamide-12 (PA-12) layer having an aging acceptance limit of less than 1.0 dl/g and preferably lower than 0.9 dl/g.

Embodiments of the present invention utilise a material comprising a PA-12 variety having characteristics which achieve good processing conditions and consistent geometries in a large diameter flexible pipe.

Embodiments of the present invention will now be described hereinafter, by way of example only, with reference to the accompanying drawings, in which:

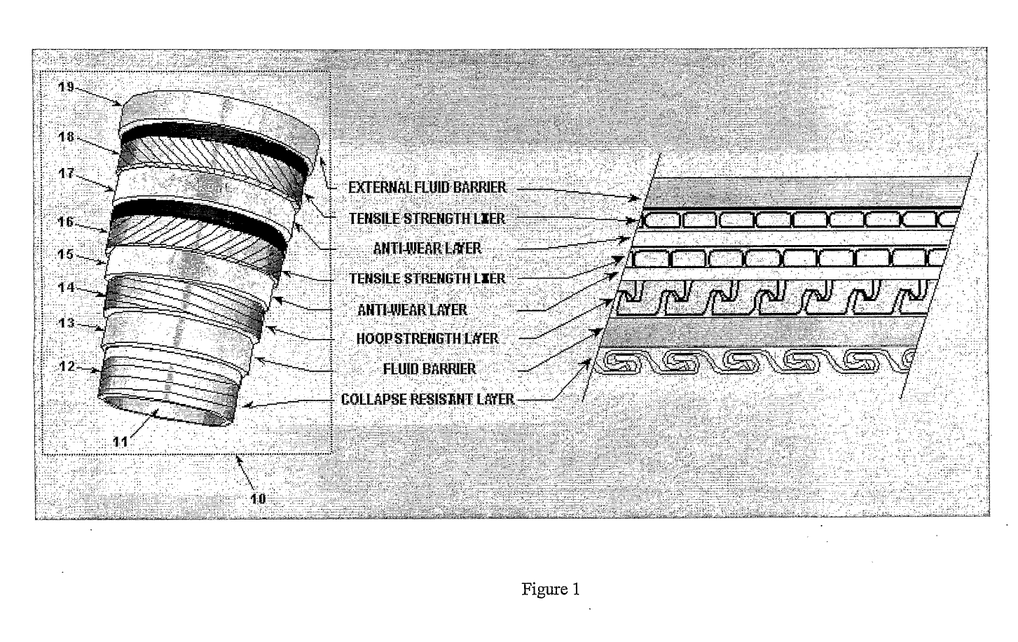

FIG. 1 illustrates a cross section through a multi-layer flexible pipe;

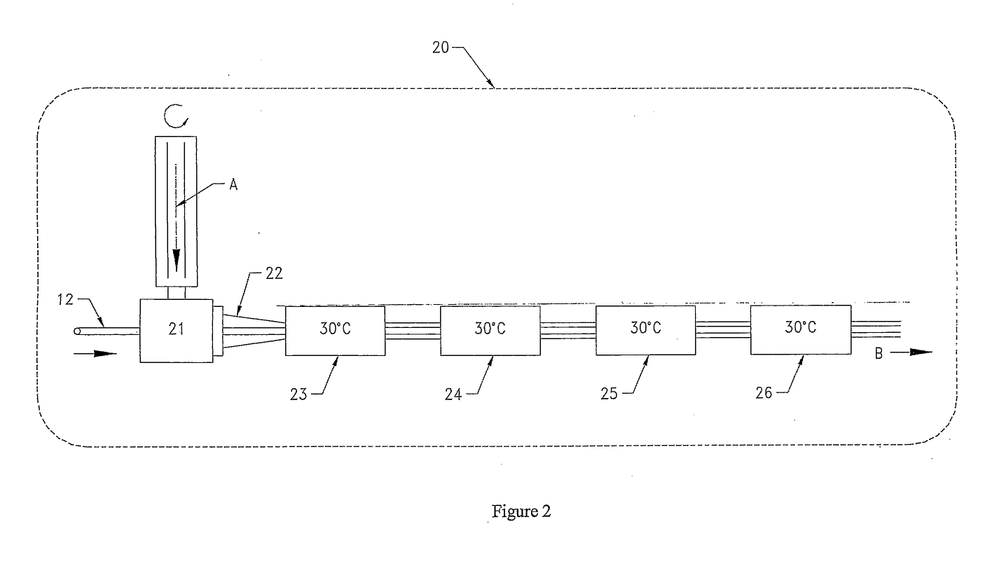

FIG. 2 illustrates an extrusion station with cooling baths; and

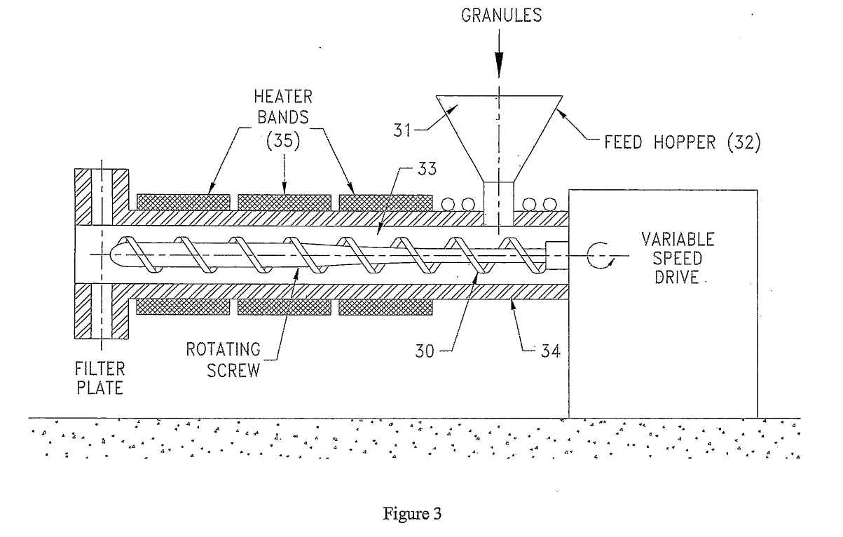

FIG. 3 illustrates another view of an extrusion station.

In the drawings like reference numerals refer to like parts. FIG. 1 illustrates a cutaway image of a flexible pipe 10 according to an embodiment of the present invention. The flexible pipe 10 is a multi-layer pipe which may be used, amongst other purposes, for conveying a fluid such as crude oil export oil or a gas. Such fluids may be referred to as typical oil and gas field fluids. Each layer of the multi-layer flexible pipe is able to move with respect to the next layer. It will be understood however that embodiments of the present invention are not restricted to any specific number of multi-layers nor to the fact that one or more of the layers may be bonded to another layer.

Fluid flows through an internal bore 11 which is formed by the inner surface of a central core layer commonly known as a carcass 12. This forms a collapse resistant layer. The core layer is formed from folded wire as is known in the art which may be permeable to fluid either outwardly from the bore or inwardly from the outside of the pipe to the inside. Such flow may either contaminate bore fluid or cause other problems such as loss of bore fluid.

A fluid barrier layer 13 is formed in the outside of the collapse resistant layer. This is formed from a thermoplastic material and thus forms a barrier polymer layer. The barrier polymer layer may be formed from one of many varieties of polyamide-12 (PA-12) layers. It will be understood that the barrier layer may itself form the inner bore along which fluid is conveyed. In such an instance the inner carcass is not required.

A hoop strength layer 14 is formed outside the fluid barrier layer and then an anti-wear layer 15 is formed. Outside the anti-wear layer is a first tensile strength layer 16 formed from wires wound in a particular direction. A further anti-wear layer 17 is then provided followed by a second tensile strength layer. An outer external fluid barrier layer 19 is formed which prevents ingress of fluid from the external surroundings of the pipe into any of the inner layers.

A variety of Polyamide (PA)-12 which is a non-standard PA 12 material is a suitable thermoplastic material for forming a flexible pipe barrier layer, having desired characteristics according to embodiments of the present invention. PA-12 is a chemical and temperature-resistant thermoplastic material that offers an excellent combination of thermal, mechanical and chemical resistance, especially to hydrocarbon fluids. By introducing a flexibilising component to PA-12 a multi-layer flexible pipe can be provided which has chemical and temperature resistance at elevated temperatures and which satisfies desirable flexibleness. One example of a material selected from the PA-12 variety according to an embodiment of the present invention is the commercially available Vestamid BS0725, which is also known as Vestamid LX9020, available from Degussa AG.

A methodology for producing this PA-12 variety is described in US 2005/0038201 which is fully incorporated herein by reference. Details from the document are repeated for the convenience of the reader. us 2005/0038201 describes a process for condensing polyamides to increase their molecular weight. The document begins by describing how polyamides are macromolecules obtained either from two different bifunctional monomer units or from single bifunctional units. One way in which polyamide molding compositions are prepared which have high melt strength is by using polyamides with high molecular weight and consequently high viscosity. Polyamides of this type are produced by a two-stage process. In this, a comparatively low-viscosity prepolymer is first prepared in a pressure reactor, for example as described in Kunststoff-Handbuch [Plastics handbook], volume 3/4 Technische Thermoplaste, Polyamide [Engineering thermoplastics, polyamides]; eds. Becker, Braun; Carl Hanser Verlag, 1998. A protic phosphorus-containing acid, e.g. H₃PO₂, H₃PO₃, or H₃PO₄ is advantageously used as a catalyst. Precursors, e.g. esters or nitrites, may also be used for the compounds needed in this process, and the precursors are converted under the reaction conditions into free acids via hydrolysis.

Other examples of compounds suitable as catalysts are organophosphonic acids or organophosphinic acids, or precursors of these. The presence of this catalyst brings about not only improved lactam cleavage at low temperatures, also resulting in a lower content of residual lactam, but also an improvement in the color of the resultant polycondensates, and there is an overall acceleration of the polycondensation reaction. The effects of the catalyzing compounds also extend, of course, to polyamides which do not contain laurolactam, but contain other monomers. The molecular weight of the precursor thus obtained in the first stage of the reaction is then raised to the required final value via reaction of the remaining end groups, for example via solid-phase post-condensation or, by way of alternative, in the melt, and this can take place in an apparatus directly connected to that for the first stage of the reaction. Various typical additives are then added to the resultant high-molecular-weight polyamide, examples being conductivity additives, stabilizers, processing aids, colorants, etc., the method generally used for this being the compounding technique known to the person skilled in the art.

This technique has a number of problems associated with it, notably using multiple sequential steps which generate additional process costs and that compensation must be allowed for the molecular weight degradation which often occurs during processing in the melt due to the action of heat and shear.

US 2005/0038201 also describes how an additive based on the use of compounds having at least two carbonate units for condensing polyamides to increase their molecular weight may be used. One such additive intended for adjustment of molecular weight of polyamides is marketed by the company Brüggemann KG with the name Brüggolen M1251. WO 00/66650 describes the use of such compounds but surprisingly use does not lead to any increase in the molecular weight of many polyamides, for example and in particular, PA-12 or co-polyamides based thereon.

US 2005/0038201 describes how it has been found that the problems discussed in relation to the use of the additive Brüggolen M1251 when used with PA-12 arise when a protic phosphorus-containing acid is used as a catalyst during the preparation of the polyamide and that the problems in such a process may be eliminated when the base corresponding to a weak acid is added in the form of a salt, the material added advantageously being a salt of a weak acid.

A process is disclosed for condensing polyamides or polyamide molding compositions to increase their molecular weight, where the polyamides or polyamide molding compositions comprise, as a result of their preparation, from 5 to 500 ppm, and in particular at least 20 ppm of phosphorus in the form of an acidic compound using a compound having at least two carbonate units, where from 0.001 to 10% by weight, based on the polyamide, of a salt of a weak acid is added to the polyamide or polyamide molding composition.

A polyamide described has a structure based on lactams, on aminocarboxylic acids, or on a combination of diamines and dicarboxylic acids. It may, furthermore, contain units with branching effect, for example those derived from tricarboxylic acids, from triamines, or from polyethyleneimine. By way of example, suitable types, in each case in the form of homopolymer or copolymer, are PA6, PA46, PA66, PA610, PA66/6, PA6-T, PA66-T, and also in particular PA612, PA1012, PA-11, PA-12, or a transparent polyamide. By way of example, transparent polyamides which may be used are:

the product from an isomer mixture of trimethylhexamethylenediamine and terephthalic acid;

the product from bis(4-aminocyclohexyl-)methane and decanedioic acid or dodecanedioic acid;

the product from bis(4-amino-3-methylcyclohexyl)methane and decanedioic acid or dodecanedioic acid.

Other suitable materials are polyetheramides based on lactams, on aminocarboxylic acids, on diamines, on dicarboxylic acids, or on polyetherdiamines, and/or on polyetherdiols.

The starting compounds preferably have molecular weights Mₙ greater than 5000, in particular greater than 8000. Preference is given to those polyamides which have at least some amino end groups. By way of example, at least 30%, at least 40%, at least 50%, at least 60%, at least 70%, at least 80%, or at least 90%, of the end groups are amino end groups.

The process uses at least one compound having at least two carbonate units, its quantitative proportion being from 0.005% to 10% by weight, calculated as a ratio to the polyamide used. This ratio is preferably in the range from 0.01 to 5.0% by weight, particularly preferably in the range from 0.05 to 3% by weight. The term “carbonate” here means carbonic ester, in particular with phenols or with alcohols.

The compound having at least two carbonate units may be of low molecular weight, oligomeric, or polymeric. It may be composed entirely of carbonate units, or it may also have other units. These are preferably oligo- or polyamide units, oligo- or polyester units, oligo- or polyether units, oligo- or polyether ester amide units, or oligo- or polyesteramide units. Compounds of this type may be prepared via known oligo- or polymerization processes, or via polymer-analogous reactions.

WO 00/66650, which is also expressly incorporated herein by way of reference, gives a detailed description of suitable compounds having at least two carbonate units.

The polyamide has to comprise a protic phosphorus-containing acid in the form of an active polycondensation catalyst, which may be added either in the form of this substance or in the form of precursors which form the active catalyst under the reaction conditions, or in the form of downstream products of the catalyst. The phosphorus content is determined to DIN EN ISO 11885 by means of ICPOES (Inductively Coupled Plasma Optical Emission Spectrometry), but one may also, by way of example, use AAS (Atomic absorption spectroscopy). It should be noted that other phosphorus-containing components may also be present in molding compositions, as stabilizers for example. In that case, a different method is used to determine the phosphorus deriving from the polycondensation. The sample preparation technique is then matched to the particular data required.

The reason underlying the effectiveness of the salt of a weak acid is that it suppresses the damaging action of the phosphorus compounds present. The pKₐ value of the weak acid here is 2.5 or higher. By way of example, suitable weak acids are selected from carboxylic acids, such as monocarboxylic acids, dicarboxylic acids, tricarboxylic acids, hydroxycarboxylic acids, aminocarboxylic acids, phenols, alcohols, and CH-acidic compounds.

Besides these, salts of weak inorganic acids are also suitable, for example carbonates, hydrogencarbonates, phosphates, hydrogenphosphates, hydroxides, sulfites, examples of suitable metals being alkali metals, alkaline earth metals, metals of main group III, or metals of transition group II. In principle, other suitable cations are organic cations, such as ammonium ions with full or partial substitution by organic radicals.

It is also possible to use salts of weak acids which are a part of macromolecular structures, for example in the form of ionomers of Surlyno (DuPont) type, or in the form of fully or partially saponified polyethylene wax oxidates.

By way of example, the following salts may be listed: aluminium stearate, barium stearate, lithium stearate, magnesium stearate, potassium oleate, sodium oleate, calcium laurate, calcium montanate, sodium montanate, potassium acetate, zinc stearate, magnesium stearate, calcium hydroxide, magnesium hydroxide, sodium phenolate trihydrate, sodium methanolate, calcium carbonate, sodium carbonate, sodium hydrogencarbonate, trisodium phosphate, and disodium hydrogenphosphate.

It is generally advantageous for the compound having at least two carbonate units to be added to the polyamide prior to the compounding process or during the compounding process, and for this compound to be incorporated by thorough mixing. Addition may take place after the compounding process, prior to processing, but in this case care has to be taken that thorough mixing occurs during processing.

The juncture of addition of the salt of a weak acid may be used to control the juncture of molecular weight increase. By way of example, the salt may be metered into the primary melt as soon as the polycondensation is complete, for instance directly into the polycondensation reactor, or into the ancillary extruder. On the other hand, it may also be applied to the polyamide pellets prior to the compounding process, e.g. in a high-temperature mixer or in a tumbling dryer. In another method, the salt is added directly during the processing of the polyamide to give the molding composition, for example together with the other additives. In these instances, the increase in molecular weight takes place before the compounding process begins, or during the compounding process. On the other hand, if the intention is to incorporate fillers or reinforcing agents during the compounding process, or if the melt filtration is to be carried out in association with the molding composition, it can be advantageous for the addition of a salt of a weak acid to be delayed until the compounding step has ended, for example by applying it to the pellets of a molding composition into which the appropriate additive having more than two carbonate units has previously been mixed, or by adding it in the form of a masterbatch, a pellet mixture being the result. The desired increase in molecular weight then takes place when the processor processes the pellets or pellet mixture thus treated, whereupon finished parts are produced.

The amount preferably used of the salt of a weak acid is from 0.001 to 5% by weight, and it is particularly preferably used from 0.01 to 2.5% by weight, and the amount used is with particular preference from 0.05 to 1% by weight, based in each case on the polyamide. The process may moreover use conventional additives used when preparing polyamide molding compositions. Illustrative examples of these are colorants, flame retardants, stabilizers, fillers, lubricants, mold-release agents, impact modifiers, plasticizers, crystallization accelerators, antistatic agents, lubricants, processing aids, and also other polymers which are usually compounded with polyamides.

Examples of these additives are the following:

Colorants: titanium dioxide, white lead, zinc white, lithopones, antimony white, carbon black, iron oxide black, manganese black, cobalt black, antimony black, lead chromate, minium, zinc yellow, zinc green, cadmium red, cobalt blue, Prussian blue, ultramarine, manganese violet, cadmium yellow, Schweinfurter green, molybdate orange, molybdate red, chrome orange, chrome red, iron oxide red, chromium oxide green, strontium yellow, molybdenum blue, chalk, ochre, umber, green earth, burnt siena, graphite, or soluble organic dyes.

Flame retardants: antimony trioxide, hexabromo-cyclododecane, tetrachloro- or tetrabromo-bisphenol and halogenated phosphates, borates, chloroparaffins, and also red phosphorus, and stannates, melamine cyanurate and its condensation products, such as melam, melem, melon, melamine compounds, such as melamine pyro- and poly-phosphate, ammonium polyphosphate, aluminum hydroxide, calcium hydroxide, and also organophosphorus compounds containing no halogen, e.g. resorcinol diphenyl phosphate or phosphonic esters.

Stabilizers: metal salts, in particular copper salts and molybdenum salts, and also copper complexes, phosphites, sterically hindered phenols, secondary amines, UV absorbers, and HALS stabilizers.

Fillers: glass fibers, glass beads, ground glass fibers, kieselguhr, talc, kaolin, clays, CaFₛ, aluminum oxides, and also carbon fibers.

Lubricants: MoS₂, paraffins, fatty alcohols, and also fatty amides. Mold-release agents and processing aids: waxes (montanates), montanic acid waxes, montanic ester waxes, polysiloxanes, polyvinyl alcohol, SiO₂, calcium silicates, and also perfluorinated polyethers.

Plasticizers: BBSA, POBO.

Impact modifiers: polybutadiene, EPM, EPDM, HDPE. Antistatic agents: carbon black, carbon fibers, graphite fibrils, polyhydric alcohols, amines, amides, quaternary ammonium salts, fatty acid esters.

The amounts used of these additives may be the usual amounts known to the person skilled in the art.

### EXAMPLES

Examples of a PA-12 variety will be illustrated by way of example below. The materials are not limited to the following examples.

Description of process:

The appropriate base polymer is fed, together with the appropriate additives, through the inlet neck of a laboratory kneader (Haake Rheocord System 90). The experimental material was brought to the appropriately adjusted melt temperature by means of heating and frictional heat. Once this temperature had been reached, the experimental material was mixed at this temperature for a further 60 seconds. The material, still hot, was then removed from the laboratory kneader. This material was used for the following analyses:

Solution viscosity ηᵣₑₗ to DIN EN ISO 307;

Amino end groups through potentiometric titration, using perchloric acid;

Carboxy end groups through visual titration, using KOH and phenolphthalein as indicator.

The results are shown in Tables 1 to 3. E here means example of a variety of PA-12 material and CE here means comparative example.

TABLE 1
Comparative examples starting from polyamides prepared
without phosphorus catalyst

| Starting material | Reference | CE 1 | Reference | CE 2 |
|---|---|---|---|---|
| PA12 | 100 | 99.4 | 0 | 0 |
| PA66 | 0 | 0 | 100 | 99 |
| Brüggolen M1251 | 0 | 0.6 | 0 | 1.0 |
| Melt temp. [° C.] | 240 | 240 | 290 | 290 |
| ηᵣₑₗ | 1.96 | 2.23 | 1.79 | 1.91 |
| NH₂ [meq./kg] | 66 | 40.6 | 34.3 | 16.3 |
| COOH [meq./kg] | 20 | 20 | 67 | 65 |

TABLE 2
Activation of Brüggolen M1251 in the case of a PA12 prepared using
hypophosphorous acid as catalyst (phosphorus content 25 ppm)

| Starting material | Reference | CE3 | E1 | E2 | E3 | E4 | E5 | E6 | CE4 | CE5 |
|---|---|---|---|---|---|---|---|---|---|---|
| PA12 | 100 | 99.4 | 99.3 | 99.3 | 99.3 | 99.3 | 99.3 | 99.3 | 99.3 | 99.3 |
| Brüggolen M1251 | 0 | 0.6 | 0.6 | 0.6 | 0.6 | 0.6 | 0.6 | 0.6 | 0.6 | 0.6 |
| Al stearate | 0 | 0 | 0.1 | 0 | 0 | 0 | 0 | 0 | 0 | 0 |
| Ca stearate | 0 | 0 | 0 | 0.1 | 0 | 0 | 0 | 0 | 0 | 0 |
| Li stearate | 0 | 0 | 0 | 0 | 0.1 | 0 | 0 | 0 | 0 | 0 |
| N a oleate | 0 | 0 | 0 | 0 | 0 | 0.1 | 0 | 0 | 0 | 0 |
| Ca laurate | 0 | 0 | 0 | 0 | 0 | 0 | 0.1 | 0 | 0 | 0 |
| Ca montanate | 0 | 0 | 0 | 0 | 0 | 0 | 0 | 0.1 | 0 | 0 |
| Stearic acid | 0 | 0 | 0 | 0 | 0 | 0 | 0 | 0 | 0.1 | 0 |
| Fatty acid ester | 0 | 0 | 0 | 0 | 0 | 0 | 0 | 0 | 0 | 0.1 |
| Melt temp. [° C.] | 240 | 240 | 240 | 240 | 240 | 240 | 240 | 240 | 240 | 240 |
| ηᵣₑₗ | 2.10 | 2.07 | 2.77 | 2.63 | 2.72 | 2.58 | 2.64 | 2.69 | 2.11 | 2.16 |
| NH₂ [meq./kg] | 51.9 | 52.7 | 22 | 24.7 | 23.8 | 26.6 | 29.5 | 27.7 | 40.7 | 43.5 |
| COOH [meq./kg] | 13 | 15 | 7 | 10 | 7 | 6 | 5 | 8 | 8 | 9 |

TABLE 3
Activation of Brüggolen M1251 in the case of other polyamides
prepared using hypophosphorous acid as catalyst (phosphorus
content in each case 25 ppm)

| Starting | | | | | | |
|---|---|---|---|---|---|---|
| material | Reference | CE6 | E7 | Reference | CE7 | E8 |
| PA612 | 100 | 99.4 | 99.3 | 0 | 0 | 0 |
| PA | 0 | 0 | 0 | 100 | 99.2 | 99.2 |
| PACM12 | | | | | | |
| Brüggolen | 0 | 0.6 | 0.6 | 0 | 0.8 | 0.8 |
| M1251 | | | | | | |
| Ca | 0 | 0 | 0.1 | 0 | 0 | 0.1 |
| stearate | | | | | | |
| Melt temp | 260 | 260 | 260 | 280 | 280 | 280 |
| [° C.] | | | | | | |
| ηᵣₑₗ | 1.85 | 1.83 | 2.00 | 1.85 | 1.85 | 1.96 |
| NH₂ | 96.8 | 97.3 | 79.8 | 40.2 | 41.7 | 18 |
| [meq./kg] | | | | | | |
| COOH | 5 | 9 | 7 | 70 | 69 | 69 |
| [meq./kg] | | | | | | |

The PA-12 material is thus varied from standard PA-12 in order to achieve increased molecular weight materials with an increased melt viscosity, thus being suitable for pipe extrusion processing. The “variation” occurs during the second of the two stages involved in preparation of the polyamide molding composition (i.e. the granules which are fed into the extruder). Whilst the first stage involves producing a comparatively low viscosity prepolymer, whereby a catalyst is used (a protic phosphorus-containing acid), the second stage (condensing polyamides to increase the molecular weight) introduces a salt of a weak acid in order to nullify the acid from the first stage. This latter step forms the basis of the “variation”.

It will also be understood that embodiments of the present invention will also comprise use of a PA-12 material including at least a key processing, heat, stabiliser and/or a UV light stabiliser together with other additives as will be understood by those skilled in the art.

FIG. 2 illustrates an extrusion station, 20, forming part of a manufacturing process for forming the flexible pipe as shown in FIG. 1. It will be understood that the manufacturing process includes many different stations each of which may be used to apply one or more of the layers shown in FIG. 1 as selected. An initial core layer, 12, is rolled into a chamber, 21, which is heated to an appropriate temperature in the range of 210° C. to 230° C. Preferably at 220° C. The core layer is a metal layer formed from interlinked wires as is known in the art.

Molten thermoplastic material is directed into the chamber, 21, known as the crosshead, along a path indicated by arrow A in FIG. 2. This movement is achieved by driving a central rotating screw within an outer casing. This is illustrated more clearly in FIG. 3. The rotating screw, 30, which has a variable diameter, is driven at a variable and selectable speed by a variable speed motor. The crosshead receives molten polymer having a delivery cross section and converts this to a new cross section having a circular cross section. This pipe like layer forms the barrier layer 12.

Granules, 31, of the polymer material which will form the barrier polymer layer are loaded into a feed hopper, 32. These granules fall into a central bore region, 33, known as a barrel. The barrel includes a cooler initial region, 34, which is commonly known as the throat. The granules are directed towards the crosshead, 21, via the barrel and rotating screw. The outside of the barrel is temperature controlled by five heater/cooler units, extending around the circumference of the barrel, as well as longitudinally along the barrel. The heater/cooler units, 35, are located to generate a desired temperature gradient from the relatively cooler throat end of the barrel close to the hopper, to the heated end, proximate to the crosshead, 21.

The heater/coolers in the throat region maintain a temperature in the barrel of between 170° C. to 190° C., preferably 180° C. The remaining heater/cooler units maintain a temperature from the throat to the crosshead of between 210° C. to 230° C. Preferably the temperature is maintained all the way along the barrel from the cooler throat region to the chamber 21 at 220° C. In this way the granules fed into the hopper will transformed into a homogenous molten state and at a desired viscosity by the time it is fed into the crosshead.

As illustrated in FIG. 2 a number of cooling baths are used to cool the barrier molten polymer so as to achieve and agreeable end product. Four cooling baths 23, 24, 25, 26 are illustrated in FIG. 2. These cooling nodes maintain a temperature in the range of 20° C. to 40° C. Preferably each cooling node is maintained at 30° C. For example an initial cooling node 23 maintains a temperature of between 20° C. to 40° C. The pipe passes through this zone for a number of seconds as it is rolled in a motion indicated by arrow B in FIG. 2. Further cooling baths are likewise set to maintain a temperature in the range of 20° C. to 40° C. and preferably 30° C.

By raising the temperature of the PA-12 to above its melting point and then re-forming and cooling into the shape of a continuous hollow profile a barrier layer can be formed around the carcass. It will be appreciated that according to further embodiments the crosshead 21 may provide a fluid barrier layer without a carcass.

Using a PA-12 variety as a barrier layer material provides a flexible pipe having a slower aging barrier layer than a flexible pipe having a barrier layer formed from PA-11. Also using PA-12 means that the aging acceptance level can be reduced compared to PA-11. Alternatively the aging acceptance limit can be set the same but knowing that a longer life time can be achieved whilst that set limit is satisfied. For example setting a threshold of a strain at break at 50% means that with a prior art PA-11 barrier layer a corrected inherent viscosity (CIV) of greater than 1.0 dl/g must be maintained. To achieve such a strain at break using a PA-12 layer in accordance with the present invention a lower threshold for the corrected inherent viscosity of 0.9 dl/g or less can provide acceptable results.

Embodiments of the present invention have been described hereinabove by way of example only. It will be understood that the present invention is not restricted to the specific details of the embodiments described. For example the flexible pipe may include only a core layer and barrier polymer layer. At least one tensile strength layer and at least one external fluid barrier layer may be also provided. Embodiments of the present invention provide a multi-layer non-bonded flexible pipe for conveying oil and gas field fluids.

Whilst the fluid barrier layer has been described as a single layer the fluid barrier layer 13 may in fact itself be formed as a multi-layer structure with only one or more of these layers being formed from the PA-12 variety as hereinabove described. Other layers in such a multi-layer barrier layer may be selected from the list of HDPE, MDPE, PP, PA-11,PA-12, TPE and/or PVDF.

Also it will be understood that embodiments of the present invention are not restricted to undersea pipe types. Rather the present invention may be applied in any pipe application where temperature resistance, chemical resistance and flexibility are desirable characteristics.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

Examples of the present invention have been described hereinabove by way of example only. It will be understood that modifications may be made to aspects of the above-described examples without departing from the scope of the present invention.

1. A multi-layer flexible pipe for conveying a target fluid, comprising:
at least one barrier layer of polyamide-12 (PA-12), for providing internal fluid integrity.

2. The multi-layer flexible pipe as claimed in claim 1 further comprising:
a core layer arranged to provide an inner bore along which a fluid can flow.

3. The flexible pipe as claimed in claim 1 or claim 2 wherein the barrier layer has sufficient ductile and fracture toughness properties to ensure that the flexible pipe will be flexible enough to be located at a desired location and to perform adequately at that location for twenty or more years, for a given cumulative temperature and chemical exposure.

4. The flexible pipe as claimed in claim 3 wherein the barrier layer has a Corrected Inherent Viscosity of greater than 1.0 dl/g, for twenty or more years in operation, for a given cumulative temperature and chemical exposure.

5. The flexible pipe as claimed in claim 3 wherein the barrier layer has a Corrected Inherent Viscosity of greater than 1.2 dl/g, for twenty or more years in operation, for a given cumulative temperature and chemical exposure.

6. The flexible pipe as claimed in claim 5 wherein said barrier layer is an extruded layer.

7. The flexible pipe as claimed in claim 6 wherein said barrier layer is a variety of Polyamide-12.

8. The flexible pipe as claimed in claim 6 wherein said barrier layer is a Polyamide-12 modified with a flexibilising component

9. The flexible pipe as claimed in claim 8 wherein said flexililising component is a liquid plasticiser.

10. The flexible pipe as claimed in claim 9 wherein said plasticiser component is N-butylbenzenesulphonamide (BBSA).

11. The flexible pipe as claimed in claim 10 wherein said barrier layer is a layer of Degussa BS0725.

12. The flexible pipe as claimed in claim 10 wherein the barrier layer is a layer of Vestamid LX9020.

13. The flexible pipe as claimed in claim 1 wherein said barrier layer comprises a barrier polymer layer.

14. The flexible pipe as claimed in claim 1 wherein said target fluid comprises crude oil.

15. The flexible pipe as claimed in claim 13 wherein said target fluid comprises a gas.

16. The flexible pipe as claimed in claim 13 wherein said target fluid comprises export oil.

17. The flexible pipe as claimed in claim 1 wherein said barrier layer comprises a bore-fluid retaining layer.

18. The flexible pipe as claim 2, wherein said barrier layer directly surrounds the core layer:

19. The flexible pipe as claimed in claim 1 wherein said multi-layer flexible pipe has three or more layers.

20. The flexible pipe as claimed in claim 1 wherein said barrier layer provides a layer with a high chemical resistance.

21. The flexible pipe as claimed in claim 1 wherein said flexible pipe comprises a non-bonded flexible pipe.

22. The flexible pipe as claimed in claim 1 wherein said core layer comprises a collapse-resistant layer.

23. The flexible pipe as claimed in claim 1 wherein said barrier layer comprises a fluid barrier layer.

24. The flexible pipe as claimed in claim 1 further comprising:
at least one tensile strength layer; and
at least one external fluid barrier layer.

25. The flexible pipe as claimed in claim 1 wherein the barrier layer is an innermost polymer extruded layer located beneath a hoop strength layer.

26. The flexible pipe as claimed in claim 1 wherein the barrier polymer layer comprises one layer of a multi-layer barrier layer.

27. The flexible pipe a claimed in claim 26 wherein the multi-layer barrier layer comprises one or more layers of a further barrier material.

28. The flexible pipe as claimed in claim 1 wherein said barrier polymer layer has a melting point of more than 170c.

29. A multi-layer flexible pipe for conveying a target fluid, comprising:
at least one barrier polymer layer of polyamide-12, for providing internal fluid integrity.

30. The multi-layer flexible pipe as claimed in claim 1, comprising:
said barrier layer is formed from a polyamide-12 material formed from a process in which a salt of a weak acid is introduced during a step of condensing polyamides to increase the molecular weight to thereby nullify acid formed in an earlier stage.

31. A method for providing a multi-layer flexible pipe for conveying a target fluid comprising the steps of:
providing at least one barrier layer of polyamide-12 (PA-12) for providing internal fluid integrity.

32. The method as claimed in claim 31 further comprising the steps of:
providing a core layer having an inner bore along which a target fluid can flow.

33. The method as claimed in claim 31 or claim 32 further comprising the steps of:
melting polyamide-12 in a food hopper;
providing the melted polymer at a crosshead chamber; and
forming a barrier layer of polyamide-12 in said crosshead.

34. The method as claimed in claim 33 further comprising the steps of:
directing polyamide-12 from said feed hopper to said crosshead via a rotating screw and associated barrel.

35. The method as claimed in claim 34 further comprising the steps of heating a throat region of the barrel to between 170° C. and 190° C.

36. The method as claimed in claim 35 further comprising the steps of heating a remaining region of the barrel to between 210° C. and 230° C.

37. The method as claimed in claim 36 further comprising the steps of heating the crosshead chamber to a temperature in the range of 21020 C. to 230° C.

38. The method as claimed in claim 37 further comprising cooling an extruded barrier layer exiting the crosshead chamber via a plurality of cooling baths.

39. The method as claimed in claim 38 wherein the temperature of each cooling bath is maintained in the temperature range of between 20□c to 40° C.

40. The method as claimed in claim 31 wherein said barrier layer is Polyamide-12 modified with a flexibilising component.

41. The method as claimed in claim 40 wherein said flexibilising component is a liquid plasticizer.

42. The method as claimed in claim 41 wherein said plasticizer is N-butylbenzenesulphonamide (BBSA).

43. The method as claimed in claim 29 wherein said barrier layer comprises a barrier polymer layer.

44. A method for providing a multi-layer flexible pipe for conveying a target fluid comprising the steps of:
providing at least one barrier polymer layer of polyamide-12 (PA-12) for providing internal fluid integrity.

45. The method as claimed in claim 44 further comprising the steps of forming a variety of polyamide-12 material via a two stage process, the second stage of the two stage process including a step of introducing a salt of a weak acid in order to nullify acid formed during the first phase.

46. A method as claimed in claim 45 wherein said PA-12 layer comprises a layer of a PA-12 variety.

47. (canceled)

48. (canceled)
